(19) United States
(12) Patent Application Publication
(10) Pub. No.: US 2025/0249940 A1
(43) Pub. Date: Aug. 7, 2025

(54) Large Capacity Battery Protective Suspension System

(71) Applicant: AMPS Traction, LLC, Westerville, OH (US)

(72) Inventor: Douglas W. Bardwell, Westerville, OH (US)

(21) Appl. No.: 19/046,132

(22) Filed: Feb. 5, 2025

Related U.S. Application Data
(60) Provisional application No. 63/549,752, filed on Feb. 5, 2024.

(51) Int. Cl. B61C 17/06; B61C 3/00; B61D 49/00; B61K 9/00; H01M 50/204; H01M 50/242; H01M 50/249

(52) U.S. Cl. CPC B61C 17/06; B61C 3/00; B61D 49/00; B61K 9/00; H01M 50/204; H01M 50/242; H01M 50/249; H01M 2220/20

(57) ABSTRACT

The disclosure includes systems and methods for a large capacity battery protective suspension for use in vehicles and structures. An example system includes at least one battery rack and at one suspension foot with at least one motion dampening device. The suspension foot reduces the impulse and shock of motion on the battery rack, and it may also limit the motion of the battery rack in the horizontal and vertical axes. Furthermore, the suspension foot may utilize a variety of motion dampening devices such as springs, gas pistons, and dashpots.

### CROSS-REFERENCE TO RELATED APPLICATION

The present application claims the benefit of U.S. Patent Application No. 63/549,752, filed Feb. 5, 2024, the content of which is herewith incorporated by reference.

### BACKGROUND

Battery electric power technologies have gained popularity in fields such as vehicle propulsion, electric grid infrastructure, and energy storage for buildings and other facilities. As such, larger battery racks and high-density battery designs have been increasingly employed in a variety of settings. A primary concern when installing such battery racks is the protection of the batteries and electrical components from shock and vibration. Accordingly, there exists a need for systems and methods for a battery rack protective suspension system.

### SUMMARY

Embodiments of the present disclosure include systems and methods for a battery rack protective suspension system.

In a first aspect, a suspension system for a battery rack within a vehicle or structure is provided. The system includes a battery rack. The battery rack includes one or more battery modules. The system also includes one or more suspension feet. The one or more suspension feet include a central connector and an outer housing. The one or more suspension feet additionally include one or more motion dampening devices that are connected to the central connector and the outer housing. The one or more suspension feet also include one or more fasteners or connectors that connect the central connector to the battery rack and the outer housing to a surrounding vehicle or structure. The system also includes one or more safety links. The one or more safety links connect the battery rack to the surrounding vehicle or structure.

In a second aspect, a system to stiffen and provide balance to two or more battery racks connected together is provided. The system includes two or more battery racks. Each battery rack includes one or more battery modules and electrical wiring to facilitate discharging the one or more battery modules. The system also includes one or more plates. The plates are connected to at least two of the two or more battery racks to stiffen the connection between the two or more battery racks. The system also includes one or more safety links. A safety link includes one or more safety rods and one or more shock absorbers connecting one of the two or more battery racks to a surrounding vehicle or structure.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE FIGURES

FIG. 1 illustrates a large capacity battery protective suspension system, according to an example embodiment.

FIG. 2 illustrates a battery rack within the large capacity battery protective suspension system, according to an example embodiment.

FIG. 3 illustrates an exploded view of a suspension foot within the large capacity battery protective suspension system, according to an example embodiment.

FIG. 4A illustrates an overview of an endcap of a motion dampening device within a suspension foot within the large capacity battery protective suspension system, according to an example embodiment.

FIG. 4B illustrates a detailed view of an inner ring of an endcap of a motion dampening device within a suspension foot within the large capacity battery protective suspension system, according to an example embodiment.

FIG. 4C illustrates a detailed view of an end plate of an endcap piece of a motion dampening device within a suspension foot within the large capacity battery protective suspension system, according to an example embodiment.

FIG. 4D illustrates a detailed view of an exterior housing of a suspension foot within the large capacity battery protective suspension system, according to an example embodiment.

FIG. 4E illustrates a detailed view of a linking component of a central connector within a suspension foot within the large capacity battery protective suspension system, according to an example embodiment.

FIG. 5 illustrates an overview of an assembled suspension foot within the large capacity battery protective suspension system, according to an example embodiment.

### DETAILED DESCRIPTION

Examples of methods and systems are described herein. It should be understood that the words “exemplary,” “example,” and “illustrative,” are used herein to mean “serving as an example, instance, or illustration.” Any embodiment or feature described herein as “exemplary,” “example,” or “illustrative,” is not necessarily to be construed as preferred or advantageous over other embodiments or features. Further, the exemplary embodiments described herein are not meant to be limiting. It will be readily understood that certain aspects of the disclosed systems and methods can be arranged and combined in a wide variety of different configurations.

It should be understood that the below embodiments, and other embodiments described herein, are provided for explanatory purposes, and are not intended to be limiting.

### I. OVERVIEW

In an example embodiment, a large capacity battery protective suspension system may include one or more battery racks carried on one or more suspension “feet”, which may provide dampening in the horizontal long-axis and vertical directions. Each suspension foot may be connected to a contiguous plate which may be connected to the deck and frame of the surrounding vehicle or structure. These connections may be made using various coupling devices, such as bolts, screws, welds, clamps, adhesives, or other fasteners. The dampening performed by the system provides additional safety and longevity to the battery rack modules, support equipment, couplers/cushions, personnel and frame. In some examples, systems described herein may be utilized in battery racks within buildings located in seismic zones (e.g., earthquake-prone areas). In such scenarios, the disclosed systems may beneficially protect the battery system from damage, malfunction, and/or fire due to a seismic event.

In some example embodiments, the system may limit the battery rack's motion in the horizontal and vertical axes, allowing the amplitude of an external impulse to be reduced by lengthening the impulse application over time. The springs used within each of the suspension feet may include locomotive-grade springs such as D-4 outer springs along the horizontal plane/axis and D-2 inner springs along a vertical plane/axis.

Some examples of the assemblies' evaluation are shown utilizing stress analysis and standard engineering design practices. In addition to the safety factors designed into the suspension feet, one or more hard link safety rods may be installed to the centerline of a given rack and connected to the surrounding vehicle or structure while one or more shock absorbers, dashpots, or other motion dampening devices may be installed to dampen the action of the system. The one or more battery racks may be connected together with various coupling devices such as plates, flange bolts, screws, welds, or other connecting techniques to stiffen the assembly while providing balance to the system. Each suspension foot assembly may also be configured to be easily inspectable by removing covers, further allowing dampening device replacement without removing the racks.

In some example embodiments, the system may include an electronic telemetry unit that may record data from at least one accelerometer providing g-force readings of the entire vehicle or structure and the battery rack individually. The electronic telemetry unit may be connected to a cellular, wired, or wireless network. By utilizing this data, the system may be optimized to protect against certain large g-force events, as well as configured to warn operators of occurrences or potential occurrences of such events. Such optimization may comprise selectively adjusting parameters of one or more motion dampening devices within the suspension feet to provide active adjustment and motion dampening. Active adjustment and motion dampening may include adjusting a center of mass of the battery rack based on the data from the electronic telemetry unit. Such optimization may also include the use of servomotors, actuators, and/or other mechanical components within the suspension feet to provide active adjustment and damping.

In some example embodiments, the panels on the outside of the battery rack may be fastened with safety screws or other secure or tamper-proof fasteners to prevent unauthorized access to the modules while allowing air to enter the system for ventilation in the event of overheating and/or gaseous discharge.

### II. EXAMPLE SYSTEMS

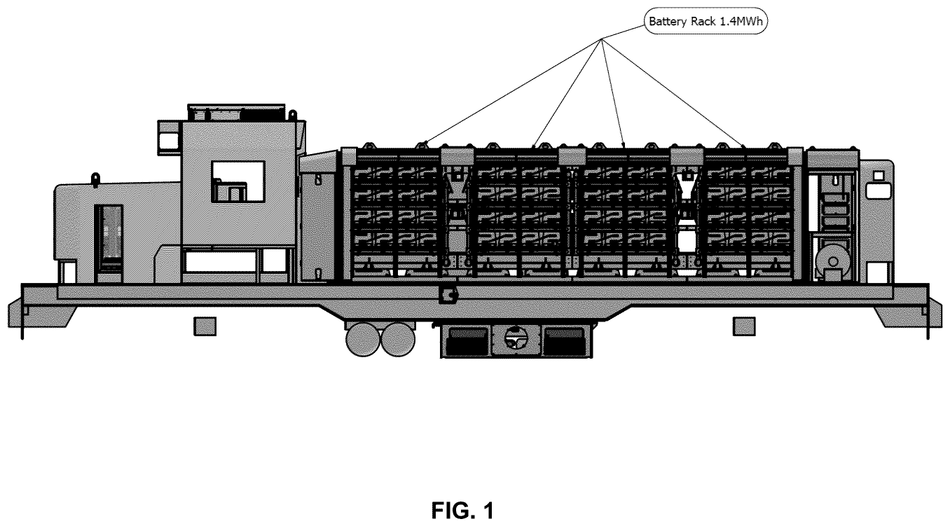

FIG. 1 illustrates an overview of the large capacity battery suspension system disposed within a battery electric locomotive, according to an example embodiment. FIG. 1 illustrates a locomotive having a large battery rack, which includes multiple smaller constituent battery racks. The number, size, and location of the battery racks may vary based on the dimensions and technical specifications of the vehicle. The locomotive also comprises support equipment for the battery racks, including power electronics, a compressor, a battery thermal management system (BTMS), a front blower motor, a rear blower motor, charging ports, and a CCS 26 air brake. The battery racks may utilize the large capacity battery suspension system specified in some example embodiments of the present disclosure to protect against shock and impulse from the motion of the locomotive.

While various described embodiments may relate to locomotive systems, it will be understood that other applications for large capacity battery suspension systems are possible and contemplated. For example, such systems may be implemented in other types of vehicles (e.g. cars, trucks, boats, airplanes, submarines, etc.). Additionally or alternatively, systems disclosed herein may be implemented in fixed structures (e.g., buildings). In such scenarios, such systems may help mitigate the effect of a seismic event.

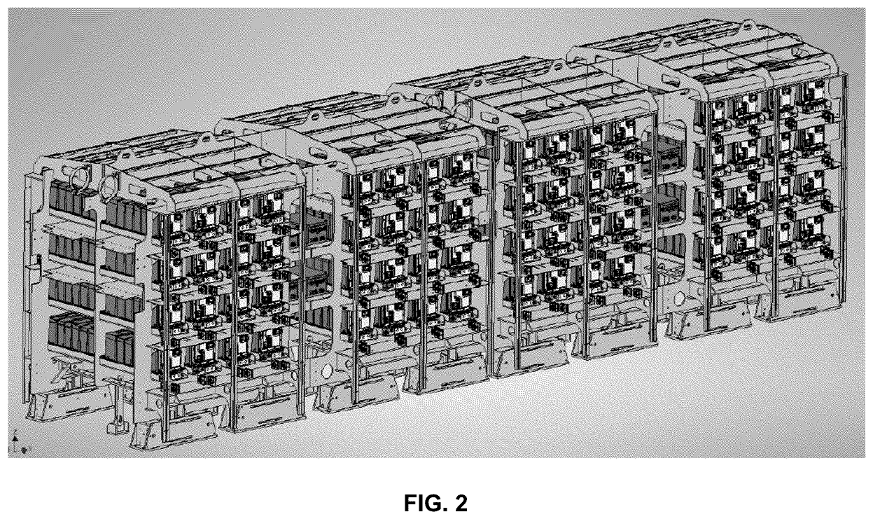

FIG. 2 illustrates an overview of a standalone battery rack and large capacity battery suspension system, according to an example embodiment. The battery rack may consist of multiple smaller constituent battery racks that are connected end-to-end or on top of each other. Additionally or alternatively, each battery rack may be connected to the surrounding vehicle or structure with one or more suspension feet and one or more safety links. In some examples, the standalone battery rack could be formed from one or more structural materials, such as steel, aluminum, carbon fiber, titanium, fiberglass, among other examples.

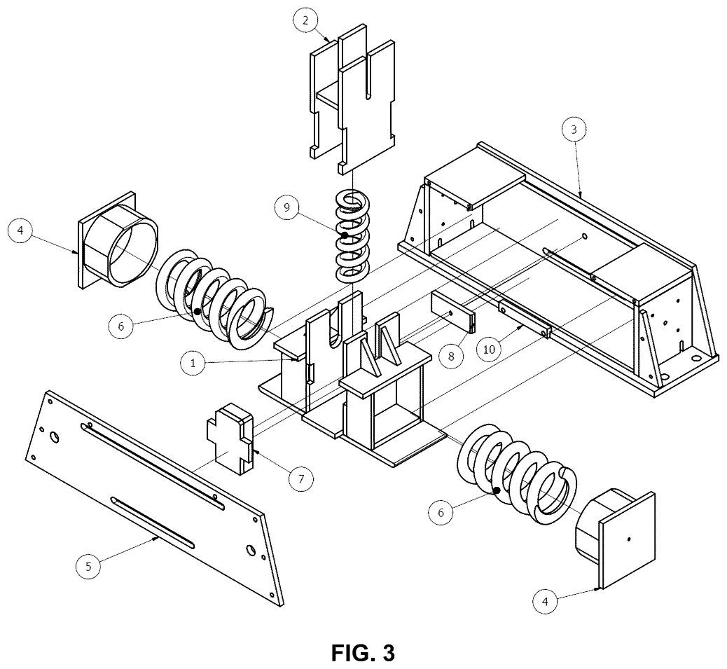

FIG. 3 illustrates an overview of an exploded view of a suspension foot, according to an example embodiment. The suspension foot consists of one or more springs 6 and 9 connected at one end to a central connector, which consists of components 1, 2, 7, and 8. Each spring is then connected at another end with endcaps 4, to an outer housing, which consists of components 3, 5, and 10. The springs 6 and 9 dampen the motion of the suspension foot and allow for a limited amount of travel of the central connector. The central connector may be connected to a battery rack, and the outer housing may be connected to the surrounding vehicle or structure. In some embodiments, one or more of the one or more springs may be a different motion dampening device, such as an elastic material, a gas piston, or a dashpot. In some examples, the suspension foot could be formed from one or more structural materials, such as steel, aluminum, carbon fiber, titanium, fiberglass, among other examples.

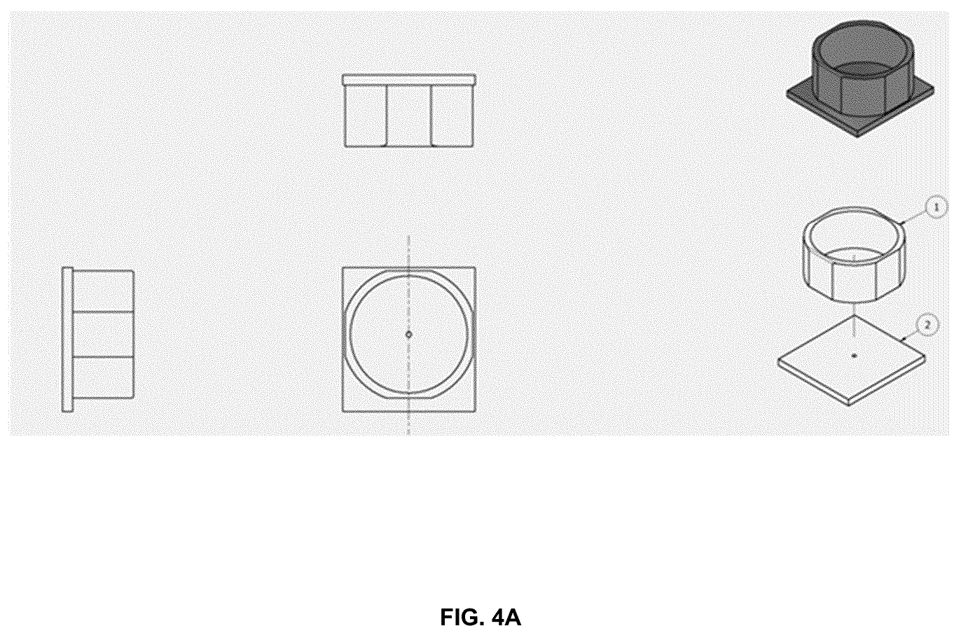

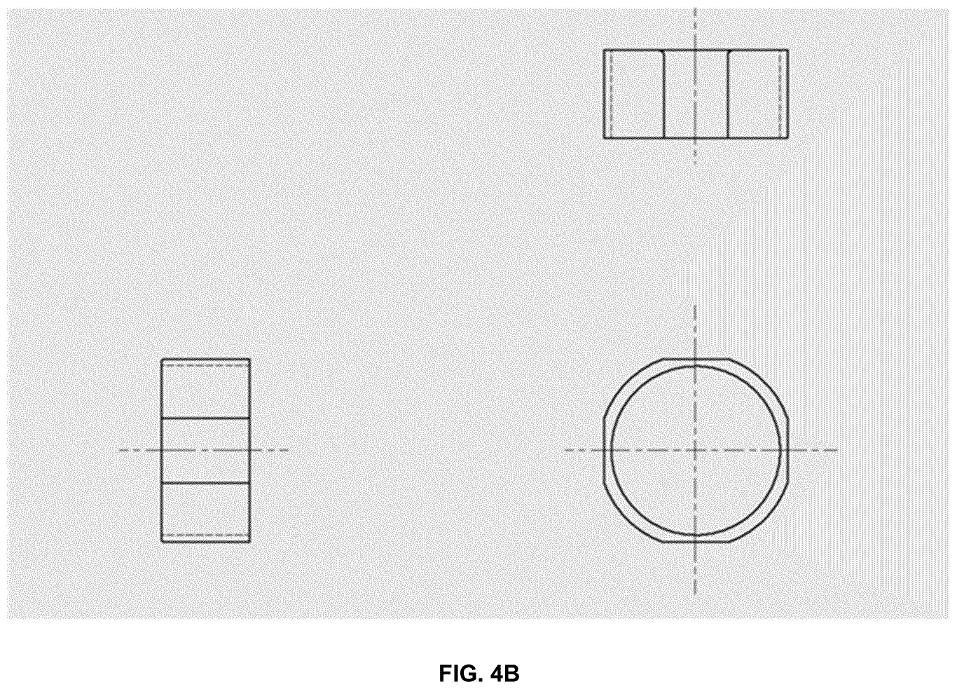

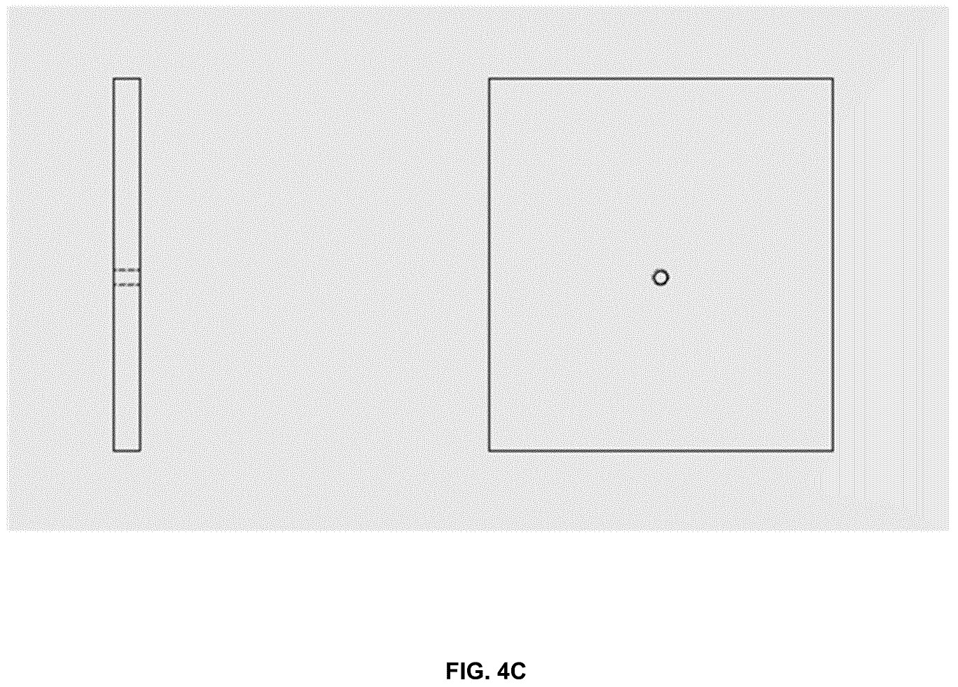

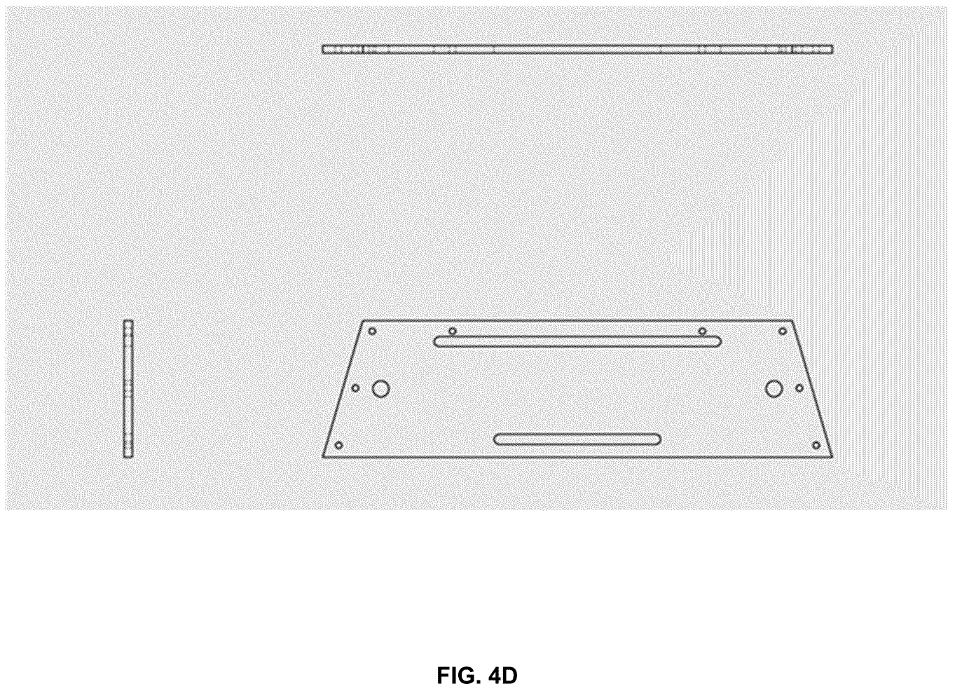

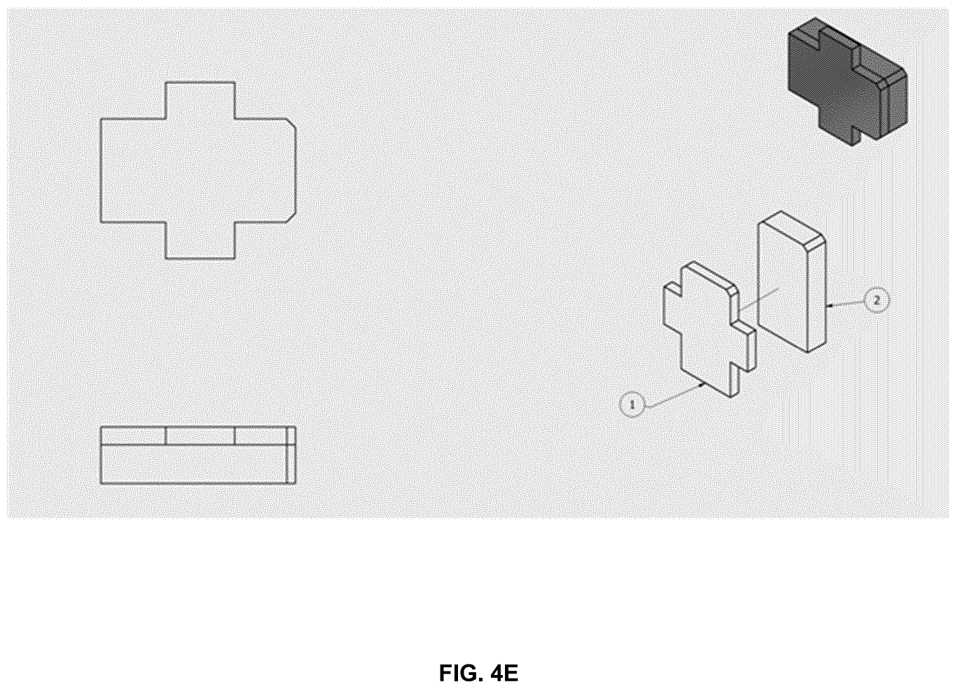

FIG. 4A illustrates an overview of the endcaps 4 of FIG. 3. The endcaps consist of an inner ring 1 and an end plate 2. The inner ring 1 may be connected to a spring or other motion dampening device. In some examples, the endcap could be formed from one or more structural materials, such as steel, aluminum, carbon fiber, titanium, fiberglass, among other examples.

FIG. 4B illustrates a detailed overview of the inner ring 1 illustrated in FIG. 4A. The inner ring may be configured or shaped to accommodate a variety of motion dampening devices and fastener standards. In some examples, the inner ring could be formed from one or more structural materials, such as steel, aluminum, carbon fiber, titanium, fiberglass, among other examples.

FIG. 4C illustrates a detailed overview of the end plate 2 illustrated in FIG. 4A. The end plate may be configured or shaped to accommodate a variety of motion dampening devices and fastener standards. The end plate may also be configured to connect with exterior components, such as the battery rack, the surrounding vehicle or structure, or another suspension foot. In some examples, the end plate could be formed from one or more structural materials, such as steel, aluminum, carbon fiber, titanium, fiberglass, among other examples.

FIG. 4D illustrates an overview of an outer housing for a suspension foot, according to an example embodiment. The outer housing may comprise one or more fastening points to which the battery rack, the internal components of the suspension foot, other suspension feet, or the surrounding environment or structure may be connected. In some examples, the outer housing could be formed from one or more structural materials, such as steel, aluminum, carbon fiber, titanium, fiberglass, among other examples.

FIG. 4E illustrates an overview of a linking component 7 of the central connector of a suspension foot, according to an example embodiment. The linking component 7 may comprise an exterior plate 1 and an interior connector 2. The exterior plate 1 may connect to the outer housing of the suspension foot, and the interior connector 2 may connect to the central connector, or to the battery rack. The interior connector may include an electronic telemetry unit that records data relating to the motion of the central connector within the suspension foot. The electronic telemetry unit may be connected to a cellular, wired, or wireless network. In some examples, the linking component could be formed from one or more structural materials, such as steel, aluminum, carbon fiber, titanium, fiberglass, among other examples.

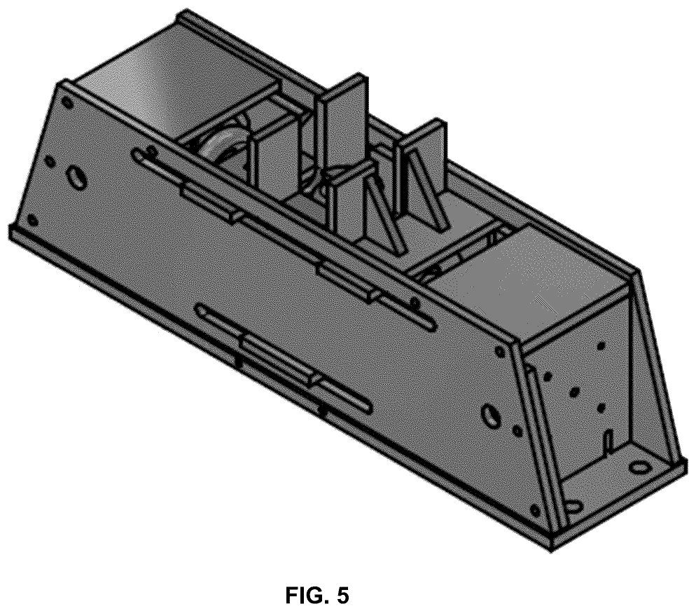

FIG. 5 illustrates an overview of an assembled suspension foot, according to an example embodiment. The suspension foot comprises an outer housing that may connect to a vehicle or a structure, and a central connector that may connect to a battery rack, allowing a limited amount of travel. Although various figures illustrate a specific shape, size, configuration, and dimensions it will be understood that other sizes, shapes, and configurations of the suspension foot are possible and contemplated within the context of the present disclosure.

### IV. CONCLUSION

The above detailed description describes various features and functions of the disclosed systems, devices, and methods with reference to the accompanying figures. In the figures, similar symbols typically identify similar components, unless context indicates otherwise. The illustrative embodiments described in the detailed description, figures, and claims are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

We claim:

1. A suspension system for a battery rack within a vehicle or structure, the system comprising:
a battery rack, wherein the battery rack comprises one or more battery modules;
one or more suspension feet, wherein the one or more suspension feet comprise:
a central connector;
an outer housing;
one or more motion dampening devices that are connected to the central connector and the outer housing;
one or more fasteners or connectors that connect the central connector to the battery rack and the outer housing to a surrounding vehicle or structure; and
one or more safety links, wherein the one or more safety links connect the battery rack to the surrounding vehicle or structure.

2. The system of claim 1, wherein the one or more suspension feet are formed from steel, aluminum, carbon fiber, titanium, or fiberglass.

3. The system of claim 1, wherein the surrounding vehicle or structure comprises at least one of: a locomotive, a train car, a car, a truck, an aircraft, a boat, or a building.

4. The system of claim 1, wherein the one or more motion dampening devices comprise at least one of: a spring, an elastic material, a gas piston, or a dashpot.

5. The system of claim 1, wherein the one or motion dampening devices comprise at least one spring, wherein the at least one spring comprises a locomotive-grade spring, wherein the locomotive-grade spring comprises a D-4 outer spring or a D-2 inner spring.

6. The system of claim 1, wherein the outer housing of the one or more suspension feet further comprises at least one inspection cover, wherein the at least one inspection cover provides visual access to the one or more motion dampening devices without need for disassembly of the system.

7. The system of claim 1, wherein the system further comprises multiple battery racks connected end-to-end or stacked on top of each other, and wherein the one or more suspension feet and the one or more safety links are connected to each of the multiple battery racks.

8. The system of claim 1, wherein the system further comprises an electronic telemetry device that comprises at least one accelerometer.

9. The system of claim 8, wherein the electronic telemetry device is connected to a cellular, wired, or wireless network connection.

10. The system of claim 9, wherein the electronic telemetry device is configured to record data that logs high g-force events that occur to the system, and wherein the electronic telemetry device is configured to transmit, by the cellular, wired, or wireless network connection, an occurrence or potential occurrence of a high g-force event when the recorded data reaches a predetermined threshold.

11. The system of claim 1, the battery rack further comprises electrical equipment to facilitate discharging the one or more battery modules.

12. The system of claim 1, wherein the one or more safety links comprise one or more safety rods and one or more shock absorbers.

13. A system to stiffen and provide balance to two or more battery racks connected together, the system comprising:
two or more battery racks, wherein each battery rack comprises one or more battery modules and electrical wiring to facilitate discharging the one or more battery modules;
one or more plates, wherein the plates are connected to at least two of the two or more battery racks to stiffen the connection between the two or more battery racks; and
one or more safety links, wherein a safety link comprises one or more safety rods and one or more shock absorbers connecting one of the two or more battery racks to a surrounding vehicle or structure.
